(19) United States
(12) Patent Application Publication
(10) Pub. No.: US 2009/0081624 A1
(43) Pub. Date: Mar. 26, 2009

(54) INTERACTIVE LEARNING APPLIANCE

(75) Inventors: CHENG-CHIH CHIEN, Taipei County (TW); TZ-SHIOU TZENG, Tainan City (TW); SEI-KANG LEE, Taipei City (TW)

Correspondence Address: ROSENBERG, KLEIN & LEE, 3458 ELLICOTT CENTER DRIVE-SUITE 101, ELLICOTT CITY, MD, 21043, US

(73) Assignee: AFAYA TECHNOLOGY CORPORATION, Taipei County (TW)

(21) Appl. No.: 12/327,302

(22) Filed: Dec. 3, 2008

Related U.S. Application Data
(63) Continuation-in-part of application No. 11/377,545, filed on Mar. 17, 2006.

(51) Int. Cl. G09B 1/36

(52) U.S. Cl. 434/171

(57) ABSTRACT

An interactive learning appliance includes a body, a plurality of puzzle pieces and a control circuit. The body defines a receptacle. The puzzle pieces are provided to be placed in the receptacle selectively. Each puzzle piece has a distinct sensing surface with at least one hole defined therein. The control circuit installed in the body includes a storage circuit, an output circuit and an identification circuit. The storage circuit stores a plurality of content files each corresponding to a combination of the selected puzzle pieces. Each content file illustrates a meaning of the combination of the selected puzzle pieces. The identification circuit is configured to recognize each of the selected puzzle pieces via the hole of the sensing surface, to find out the corresponding content file according to an identification result of the selected puzzle pieces, and to have the output circuit execute the corresponding content file.

### CROSS REFERENCE TO RELATED APPLICATION

This is a continuation-in-part of co-pending application Ser. No. 11/377,545, filed on Mar. 17, 2006.

### BACKGROUND OF INVENTION

1. Field of Invention

This invention relates generally to educational appliances and more particularly to interactive learning appliances for providing a user with a fun interactive learning experience.

2. Related Prior Art

It's been a long time that people desire to learning with fun. To date, all attempts to have a fun learning through the use of educational tools. A conventional learning tool, for example, a jigsaw puzzle or a spelling game is familiar.

However, no matter what the spelling result comes out, it suffers from a disadvantage of providing pleasant looking only but not teaching anything else. The meanings of the outcome need to be analyzed and interpreted by a human being. F or example, the word with characters, such as B-A-N-A-N-A spelled by a child, need to be read and explained by an adult. Users need assistance from other persons to obtain satisfied learning effect, and therefore the learning effect is inferior.

From the foregoing, there is still room for providing a new learning appliance that improves the learning efficiency in fun, easy-to-use way.

### SUMMARY OF INVENTION

Broadly stated, the present invention is directed to an interactive learning appliance. The interactive learning appliance includes a body, a plurality of puzzle pieces and a control circuit. The body defines a receptacle therein. The puzzle pieces are provided to be placed in the receptacle selectively. Each puzzle piece has a distinct sensing surface with at least one hole defined therein. The control circuit installed in the body includes a storage circuit, an output circuit, an identification circuit and an interface circuit interconnected with one another.

Specifically, the storage circuit stores a plurality of content files each corresponding to a combination of the selected puzzle pieces. Each content file illustrates a meaning of the combination of the selected puzzle pieces. The identification circuit is configured to identify each of the selected puzzle pieces via the hole of the sensing surface, to find out the corresponding content file according to an identification result of the selected puzzle pieces, and to have the output circuit execute the corresponding content file. The interface circuit is provided to be interconnected with an output device and is configured to transform a format of the corresponding content file of the identification circuit into another format readable by the output device so as to have the output device execute the corresponding content file.

The advantages of the present invention will be understood more readily after a consideration of the drawings and the Detailed Description.

### BRIEF DESCRIPTION OF DRAWINGS

The invention is illustrated by the accompanying drawings in which corresponding parts are identified by the same numerals and in which:

FIG. 1 is a perspective view of an interactive learning appliance according to a first embodiment of the present invention, showing the six selected puzzle pieces named B, A, N, A, N, A being placed in the receptacle of the body;

FIG. 2 is a view similar to FIG. 1, showing the four selected puzzle pieces named A, N, A, N being placed in the receptacle of the body;

FIG. 3 is a block diagram illustrating the control circuit of the interactive learning appliance; and

FIG. 4 is a block diagram illustrating the identification circuit of the control circuit of the interactive learning appliance.

FIG. 5 is a perspective view of a second embodiment of the present invention,

### DETAILED DESCRIPTION OF THE PREFERRED EMBODIMENT

Referring now to the drawings, an interactive learning appliance according to the preferred embodiment of the present invention comprises a body 1, a plurality of puzzle pieces 2 and a control circuit 3.

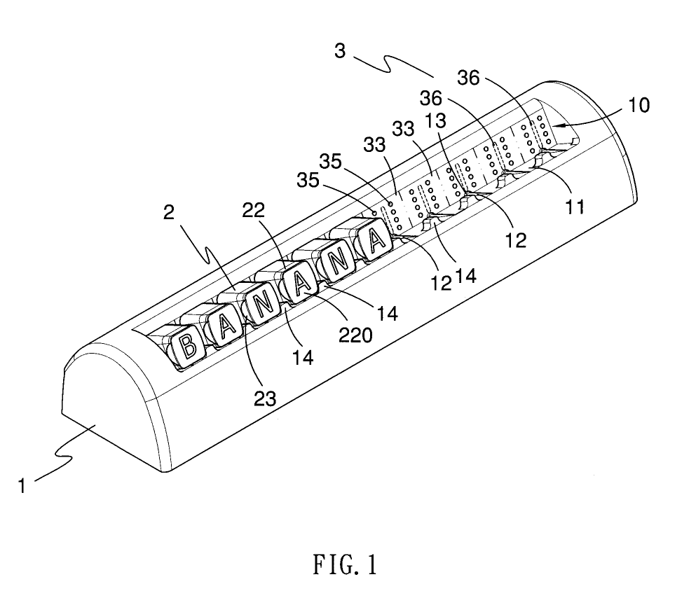

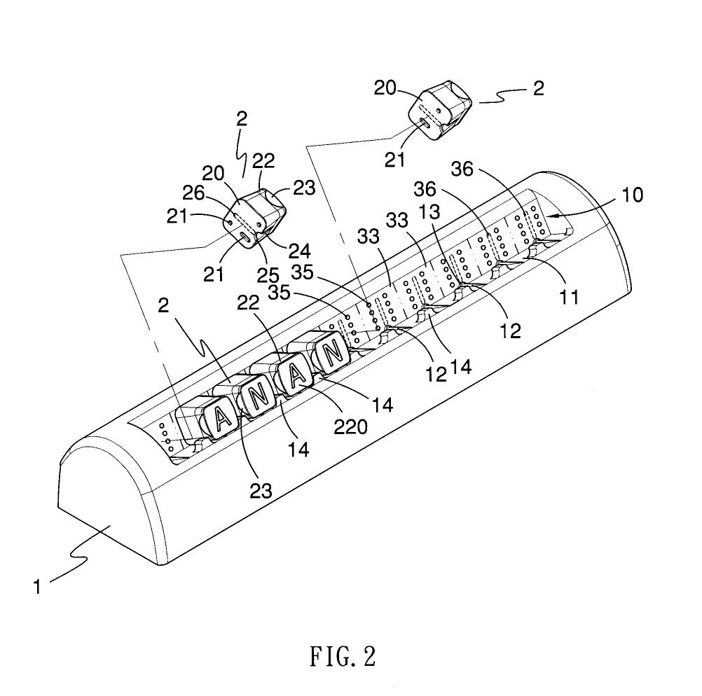

Referring to FIGS. 1 and 2, the body 1 defines a receptacle 10 therein to receive a certain number of the puzzle pieces 2 so that the puzzle pieces 2 can be placed in the receptacle 10 selectively. As best seen in FIG. 2, each puzzle piece 2 has a distinct sensing surface 20 with at least one hole 21 defined therein to be identified. In other words, the disposition of the hole 21 varies with each puzzle piece 2.

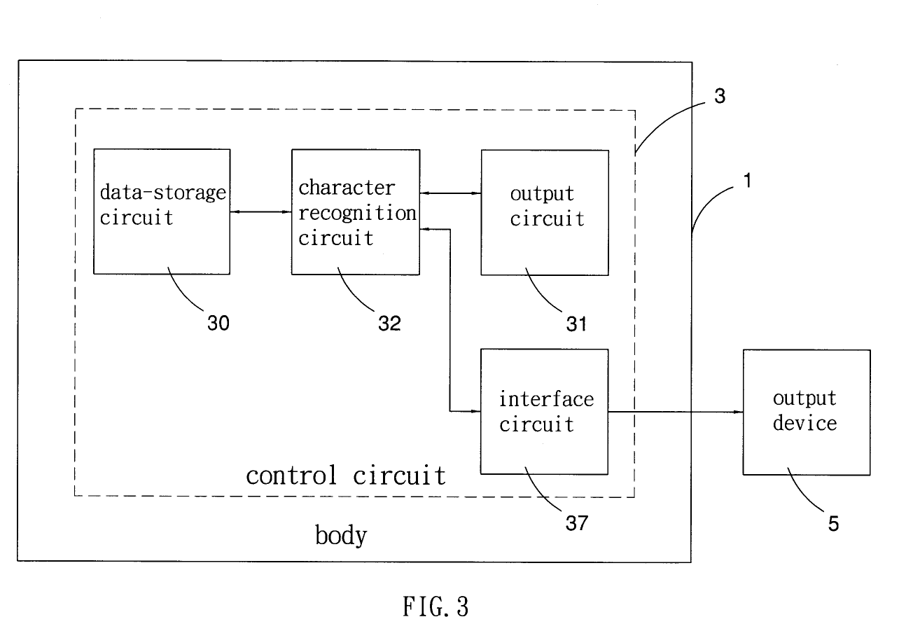

As shown in FIG. 3, the control circuit 3 is installed in the body 1 and includes a storage circuit 30, an output circuit 31, an identification circuit 32 and an interface circuit 37. The storage circuit 30 stores a plurality of content files each corresponding to a combination of the selected puzzle pieces 2, such as the combination of “BANANA” in FIG. 1. The content file is a primary digital file containing audio, image, video text, or other to illustrate a meaning of the combination of the selected puzzle pieces 2. The output circuit 31, such as a MP3 player circuit, is configured to execute the content file under an order of the identification circuit 32. The interface circuit 37 is provided to be interconnected with an output device 5, such as a TV. The interface circuit 37 enables the output device 5 to execute the corresponding content of the content files.

The identification circuit 32 of the control circuit 3 is configured to recognize each of the selected puzzle pieces 2 via the hole 21 of the sensing surface 20 when the selected puzzle pieces are placed in the receptacle 10. Additionally, the identification circuit 32 is configured to find out the corresponding content file according to an identification result of the selected puzzle pieces 2 and then to have the output circuit 31 execute the corresponding content file.

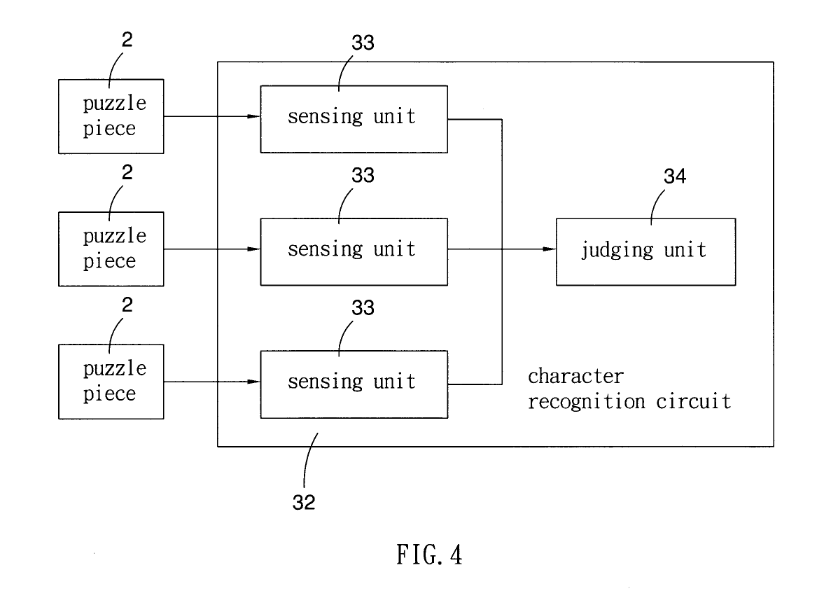

Specifically, referring to FIGS. 2 and 4, the identification circuit 4 includes a judging unit 34 and a plurality of sensing units 33 placed side by side in the receptacle 10. Each of the sensing units 33 includes a plurality of membrane switches 35 formed thereon. When the selected puzzle pieces 2 are placed in the receptacle 10 to abut against the sensing units 33 respectively, at least one of the membrane switches 35 of each of the corresponding sensing units 33 is received in the hole 21 of the sensing surface 20 of the respective puzzle piece 2 while others are pressed by the sensing “surface” of the respective puzzle piece 2 except the hole 21. The judging unit 34 is configured to identify IDs and locations of the selected puzzle pieces 2 so as to get the identification result via the pressed/unpressed membrane switches 35 of the corresponding sensing units 33. According to the identification result, the judging unit 34 finds out the corresponding content file and have the output circuit 31 execute the corresponding content file.

The interface circuit 37 is configured to transform a format of the corresponding content file of the identification circuit 32 into another format readable by the output device 5 so as to have the output device 5 execute the corresponding content file. In other words, the content files can be executed by either one of the interior output circuit 31 and the exterior output device 5.

Referring again to FIG. 2, the receptacle 10 is formed with a slope wall 11 therebottom from outside toward the sensing units 33 to guide the puzzle pieces 2 into the receptacle 10. The slope wall 11 is formed with a plurality of guide rails 12 each corresponding to a respective one of the sensing units 33. Each guide rail 12 extends from an inner edge adjacent to the sensing unit 33 to an outer edge of the slope wall and is tapered from the inner edge to the outer edge. Additionally, a flange 13 is formed at one end of the guide rail 12 adjacent to the sensing unit 33.

Furthermore, the slope wall 11 is formed with a plurality of protrusions 14 on the outer edge. The protrusions 14 of the slope wall 11 are spaced at a distance which is the width of a holding portion 22 of the puzzle piece 2. The holding portion 22 is opposite to the sensing surface 20. Each puzzle piece 2 is tapered from the sensing surface 20 to the holding portion 22. The holding portion 22 is sized to be located in between adjacent two of the protrusions 14 and is formed with two cambered surfaces 23 at opposite sides for easy grabbing. In addition, the holding portion 22 has an end surface 220 with texts or patterns defined thereon.

Moreover, each puzzle piece 2 defines a guide groove 24 in a bottom side thereof corresponding to a respective one of the guide rails 11 of the slope wall 11. The guide groove 24 extends from a side the sensing surface 20 toward the holding portion 22 and is tapered from one side to another. Moreover, the guide groove 24 including a recess 25 defined in the side of the sensing surface 20 to be coupled with the flange 13 of the guide rail 12. In such a configuration, when being placed in the receptacle 10, the puzzle piece 2 is able to slide along the guide rail 11 and exactly press against the sensing unit 33 with its sensing surface 20.

The interactive learning appliance further comprises a plurality of magnetic members 36 disposed in the receptacle 10 of the body 1. On the other hand, each puzzle piece 2 has a magnetic portion 26 corresponding to the magnetic members 36 in such a way that each of the puzzle pieces 2 is able to be secured in the receptacle 10 with its sensing surface 20 pressing against the membrane switches 35 of respective sensing unit 33. In this embodiment, the magnetic portion 26 is attached to the sensing surface 20 of the puzzle piece 2. In other example, the sensing surface may be made of a magnetic material to be served as the magnetic portion 26.

In practice, when the six selected puzzle pieces 2 named B, A, N, A, N, A are placed in the receptacle 10 in series as shown in FIG. 1, the judging circuit 34 of the identification circuit 32 is actuated as a result of the corresponding membrane switches 35 of the sensing units 33 being pressed by the sensing surfaces 20 of the selected puzzle pieces 2 and then recognizes that the IDs and locations of the selected puzzle pieces 2 are “B, A, N, A, N, A”. According to the identification result, the judging circuit 34 finds out the corresponding content file and then have the output circuit 31 execute the corresponding content file. Then the output circuit 31 is executed by sending out a sound of “banana” in Chinese or explaining the meaning of the word “banana”. Otherwise, if the only four puzzle pieces 2 named A, N, A, N are placed in the receptacle 10 in series as shown in FIG. 2, the output circuit 31 sending out nothing because no corresponding content file is defined in the storage circuit 30 in advance.

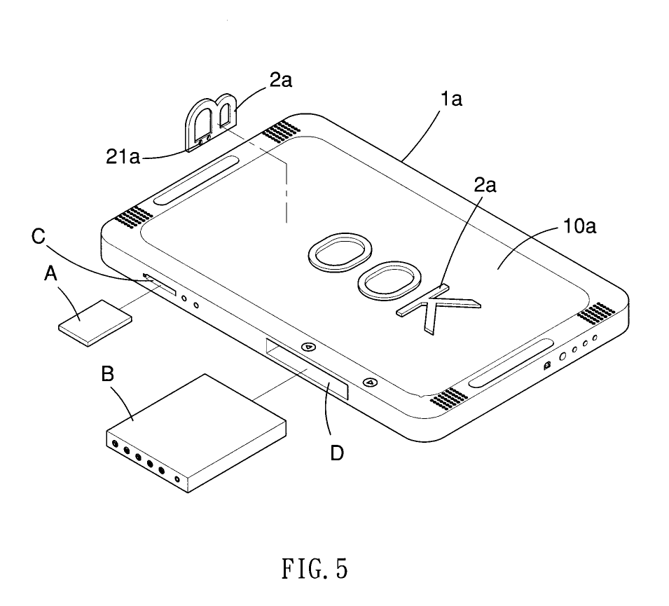

An interactive learning appliance in accordance with a second embodiment of the present invention is illustrated in FIG. 5 as comprising a body 1a, a plurality of puzzle pieces 2a and a control circuit (not shown). The body 1a defines a receptacle 10a therein. Each puzzle piece 2a has at least one hole 21a defined in its sensing surface. The control circuit is installed in the body 1a and includes a storage circuit, an output circuit and an identification circuit, as mentioned in the first embodiment. The storage circuit stores a plurality of content files. Briefly, the second embodiment is similar to the first embodiment of FIGS. 1-4 except that the receptacle 10a of the second embodiment is flat as a panel. Moreover, the storage circuit is packaged as a memory card A and the output circuit is packaged as a MP3 player B. In addition, the body 1a defines two slots C, D corresponding to the memory card A and the MP3 player B for receiving the same respectively. Only when the memory card A and the output MP3 player B are received in the slots C, D respectively, the storage circuit and the output circuit are connected to the identification circuit, and therefore, the control circuit is set up. Additionally, the identification circuit uses light to detect the hole 21a of the sensing surface of the puzzle piece 2a, and thereby achieving the purpose of identifying the identity of each puzzle piece 2a.

It will be appreciated that although particular embodiments of the invention have been shown and described, modifications may be made. It is intended in the claims to cover such modifications which come within the spirit and scope of the invention.

The invention claimed is:

1. An interactive learning appliance comprising:
a body defining a receptacle therein;
a plurality of puzzle pieces provided to be placed in the receptacle selectively and each puzzle piece having a distinct sensing surface with at least one hole defined therein to be identified; and
a control circuit installed in the body and including a storage circuit, an output circuit and an identification circuit; the storage circuit storing a plurality of content files each corresponding to a combination of the selected puzzle pieces; the content file illustrating a meaning of the combination of the selected puzzle pieces; the identification circuit configured to recognize each of the selected puzzle pieces via the hole of the sensing surface, to find out the corresponding content file according to an identification result of the selected puzzle pieces, and to have the output circuit execute the corresponding content file.

2. The interactive learning appliance of claim 1, wherein the identification circuit includes a judging unit and a plurality of sensing units placed side by side in the receptacle; each of the sensing units includes a plurality of membrane switches formed thereon; when the selected puzzle pieces are placed in the receptacle to abut against the sensing units respectively, at least one of the membrane switches of each of the corresponding sensing units is received in the hole of the sensing surface of the respective puzzle piece while others are pressed by the sensing surface of the respective puzzle piece except the hole; and the judging unit is configured to identify IDs and locations of the selected puzzle pieces to get the identification result via the pressed membrane switches of the corresponding sensing units, find out the corresponding content file and have the output circuit execute the corresponding content file.

3. The interactive learning appliance of claim 2 further comprising a plurality of magnetic members disposed in the receptacle of the body, and each puzzle piece having a magnetic portion corresponding to the magnetic members in such a way that each of the puzzle pieces is able to be secured in the receptacle with its sensing surface pressing against the membrane switches of respective sensing unit.

4. The interactive learning appliance of claim 2, wherein the receptacle has a slope wall from outside to the sensing units to guide the puzzle pieces into the receptacle; the slope wall is formed with a plurality of guide rails each corresponding to a respective one of the sensing units; each puzzle piece defines a guide groove in a side corresponding to a respective one of the guide rails of the slope wall in such a way that when being placed in the receptacle, the puzzle piece is able to slide along the guide rail and exactly press against the sensing unit with its sensing surface.

5. The interactive learning appliance of claim 3, wherein the receptacle has a slope wall from outside toward the sensing units to guide the puzzle pieces into the receptacle; the slope wall is formed with a plurality of guide rails each corresponding to a respective one of the sensing units; each puzzle piece defines a guide groove in a side corresponding to a respective one of the guide rails of the slope wall in such a way that when being placed in the receptacle, the puzzle piece is able to slide along the guide rail and exactly press against the sensing unit with its sensing surface.

6. The interactive learning appliance of claim 4, wherein each puzzle piece has a holding portion opposite the sensing surface and is tapered from the sensing surface to the holding portion; and the holding portion is formed with two cambered surfaces at opposite sides.

7. The interactive learning appliance of claim 5, wherein each puzzle piece has a holding portion opposite the sensing surface and is tapered from the sensing surface to the holding portion; and the holding portion is formed with two cambered surfaces at opposite sides.

8. The interactive learning appliance of claim 6, wherein the slope wall is formed with a plurality of protrusions on an outer edge thereof; and the protrusions of the slope wall are spaced at a distance which is the width of the holding portion of the puzzle piece.

9. The interactive learning appliance of claim 7, wherein the slope wall is formed with a plurality of protrusions on an outer edge thereof; and the protrusions of the slope wall are spaced at a distance which is the width of the holding portion of the puzzle piece.

10. The interactive learning appliance of claim 2, wherein the control unit further includes an interface circuit to be interconnected with an output device; the interface circuit is configured to transform a format of the corresponding content file of the identification circuit into another format readable by the output device so as to have the output device execute the corresponding content file.
